(19) United States
(12) Patent Application Publication
(10) Pub. No.: US 2014/0144010 A1
(43) Pub. Date: May 29, 2014

(54) ASSEMBLY STAND FOR PUTTING RAILCAR BODY UNITS TOGETHER

(71) Applicants: Walter Gaspers, Duisburg (DE); Reinhard Kloss, Gelsenkirchen (DE); Kay Lindenau, Krefeld (DE); Bernd Niesel, Kerken (DE); Ryszard Zielinski, Duesseldorf (DE)

(72) Inventors: Walter Gaspers, Duisburg (DE); Reinhard Kloss, Gelsenkirchen (DE); Kay Lindenau, Krefeld (DE); Bernd Niesel, Kerken (DE); Ryszard Zielinski, Duesseldorf (DE)

(73) Assignee: SIEMENS AKTIENGESELLSCHAFT, MUENCHEN (DE)

(21) Appl. No.: 14/005,323

(22) PCT Filed: Feb. 13, 2012
(86) PCT No.: PCT/EP2012/052374

§ 371 Date: Jan. 21, 2014

(30) Foreign Application Priority Data
Mar. 16, 2011 (DE) 10 2011 005 632.7

(51) Int. Cl. B23P 19/04

(52) U.S. Cl. CPC B23P 19/04
USPC 29/700

(57) ABSTRACT

An assembly stand that is suitable for putting railcar body units together to form a railcar body of a railway vehicle, includes an inner unit having a longitudinal beam which is present in the interior of the railcar body while the railcar body is being put together, extends along the longitudinal axis of the railcar body, and can be positioned in the interior of the railcar body.

The invention relates to an assembly stand which is suitable for putting railcar body units together to form a railcar body of a railway vehicle.

Nowadays assembly stands are usually designed specifically for each railcar body which is to be assembled, thus by way of example for high-speed railcar bodies or regional-rail railcar bodies. In the event of changing over a product, adapting the assembly stands is as a rule time and cost intensive.

Furthermore the problem exists that when putting together railcar body units to form a finished railcar, distortions in the Y-direction, for example distortions of the side walls, have to be compensated by introducing forces in the horizontal direction from outside and inside as well as in the Z-direction (vertical direction). This leads to considerable expense in the case of the assembly stands which are already known, since manual preparations for the welded seams, manual positioning, fixing and joining work, manual setting-up work, manual welding work as well as manual alignment work are all necessary.

The object of the invention is therefore to produce an assembly stand which enables a particularly cost-effective production of railcar bodies.

This is achieved according to the invention by an assembly stand having the features according to patent claim 1. Advantageous developments of the assembly stand according to the invention are provided in the dependent claims.

It is accordingly proposed according to the invention that the assembly stand has an inner unit having a longitudinal beam which is present in the interior of the railcar body while the railcar body is being put together, extends along the longitudinal axis of the railcar body, and can be positioned in the interior of the railcar body.

One important advantage of the assembly stand according to the invention can be seen in that this enables an automated finishing of the railcar body from the interior of the railcar body. By means of the longitudinal beam which can be moved in the interior of the railcar body, tools, such as by way of example welding appliances, can be positioned and controlled inside the interior of the railcar body so that by way of example an automated welding is possible from the interior of the railcar body.

A further important advantage of the assembly stand according to the invention lies in the fact that the longitudinal beam of the inner unit can also be used to support the roof of the railcar body. If namely the roof of the railcar body is set down on the under-frame, the longitudinal beam need only be moved into a position which is suitable for taking up the roof load; this can take place automatically by way of example by means of a computer control.

A third important advantage of the assembly stand according to the invention lies in the fact that, with this, railcar bodies can also be put together which have no interior struts. As opposed to the conventional assembly stands the longitudinal beam of the inner unit can in fact be used to hold or support from inside parts of the railcar body which are to be attached from the outside, whilst these are fastened, by way of example welded on.

It has been considered particularly advantageous if the longitudinal beam has a guide device for tools with which the tools are movable along the longitudinal axis of the longitudinal beam. By way of example welding appliances can be attached movable on the longitudinal beam as tools which for the purpose of welding the railcar body units together move up to the proposed welding sites and are used there, by way of example through computer monitoring.

It is considered particularly advantageous if the longitudinal beam is dimensioned so that it can support the roof of the railcar body from the inside when putting together the railcar body. Such dimensioning of the longitudinal beam enables a double function, namely on the one hand the function of an inner support member for supporting the roof and on the other hand the support function for movable tools with which the roof is welded on by way of example from inside.

In order to enable a targeted alignment of the railcar body roof it is considered advantageous if one or more preferably individually movable (e.g. vertically and/or along the longitudinal axis of the longitudinal beam) support devices are attached to the upper side of the longitudinal beam so that the railcar body roof rests thereon during attachment to the railcar body. Through a targeted movement of the support devices it is possible to adjust the position of the railcar body roof specifically relative to the remaining railcar body before finally fixing the railcar body roof.

As already mentioned, it is regarded as advantageous if tools, such as by way of example, welding appliances, are attached movably on the longitudinal beam. With such a development it is particularly advantageous if the longitudinal beam provides at the same time a mass introduction for the welding process.

A mass introduction of this kind can be formed by way of example by the movable support devices already mentioned above.

It is furthermore considered advantageous if the assembly stand has one or more of the following means:

means for centering the under-frame of the railcar body,
means for discharging the under-frame of the railcar body, means for pressing down the railcar body roof in the direction of the under-frame, means for picking up, transporting and/or positioning the end walls of the railcar body.

The invention will now be explained in further detail with reference to the embodiments; these show by way of example

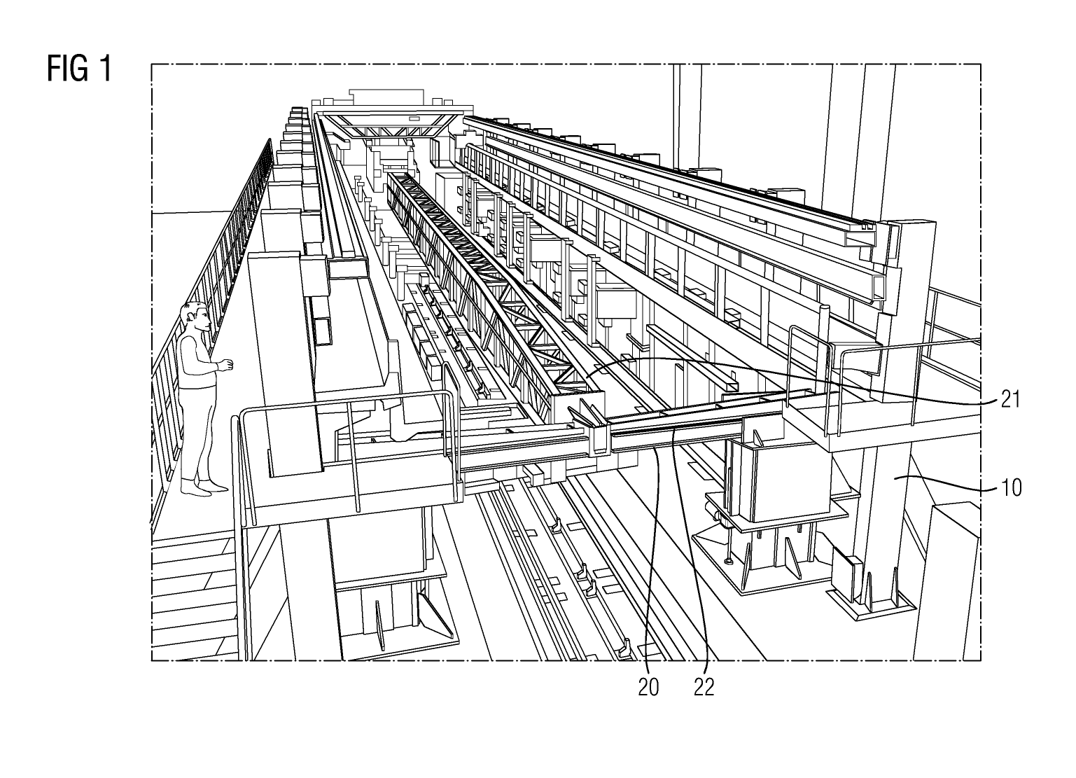

FIG. 1 an embodiment for an assembly stand according to the invention in a three-dimensional view;

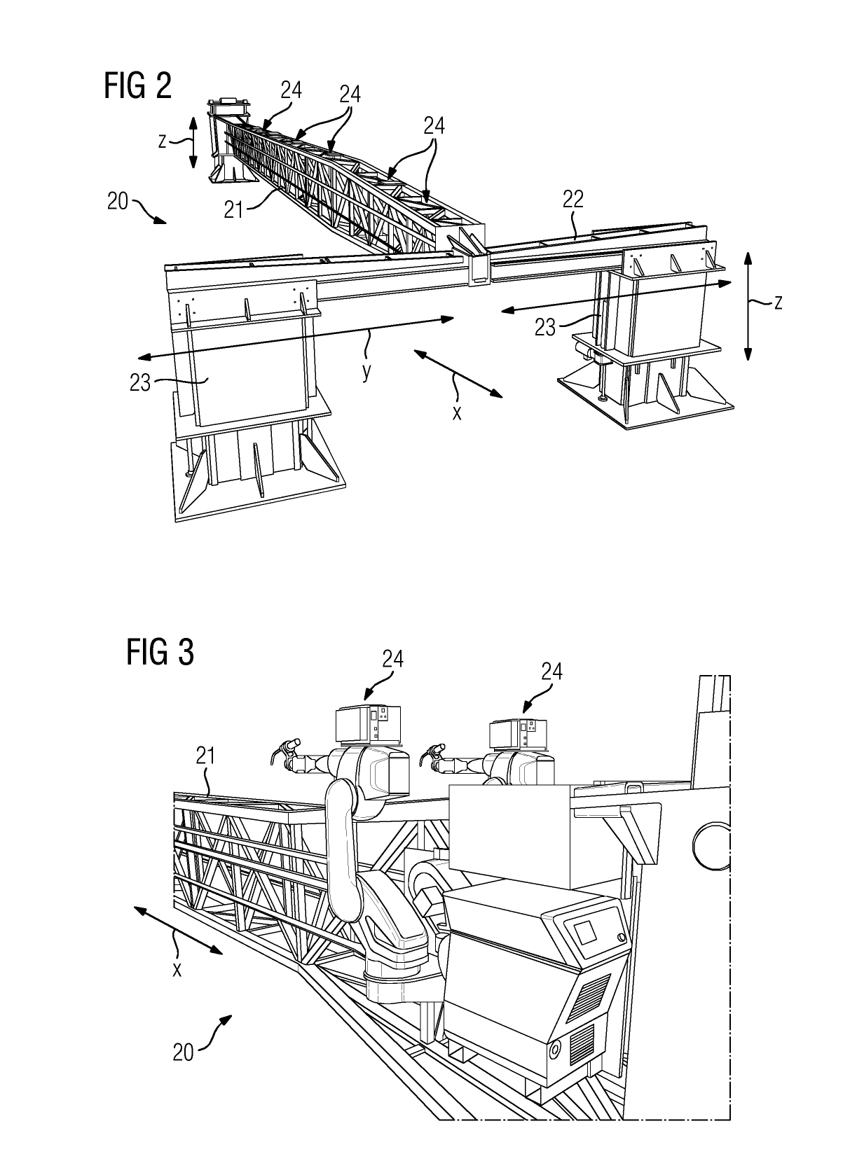

FIG. 2 an embodiment for an inner unit for the assembly stand according to FIG. 1;

FIG. 3 the inner unit according to FIG. 2 in more detail;

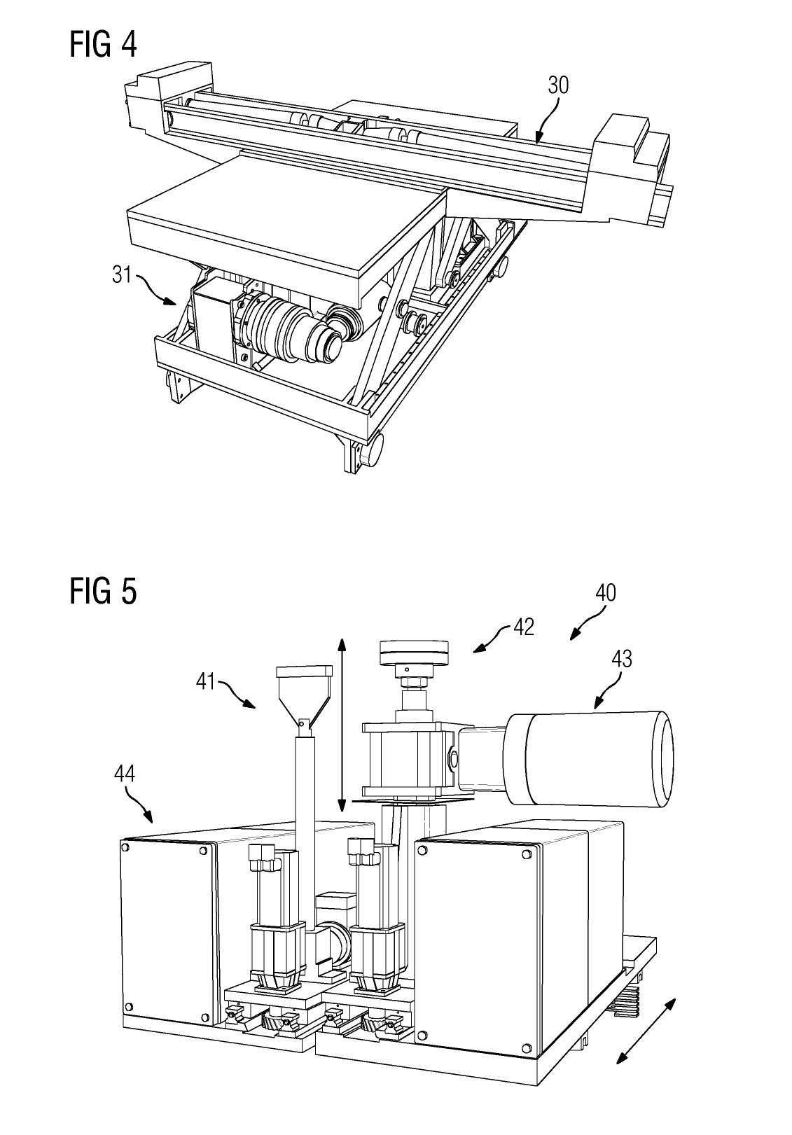

FIG. 4 an embodiment for a scissor-lift table for a transport unit of the assembly stand according to FIG. 1;

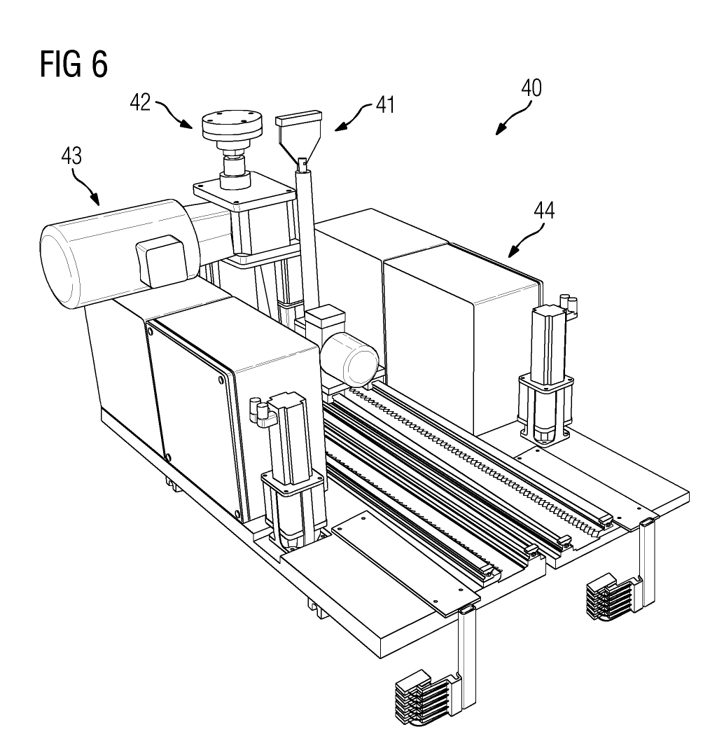

FIG. 5 an embodiment for a discharge unit for the assembly stand according to FIG. 1;

FIG. 6 the discharge unit according to FIG. 5 in a different view;

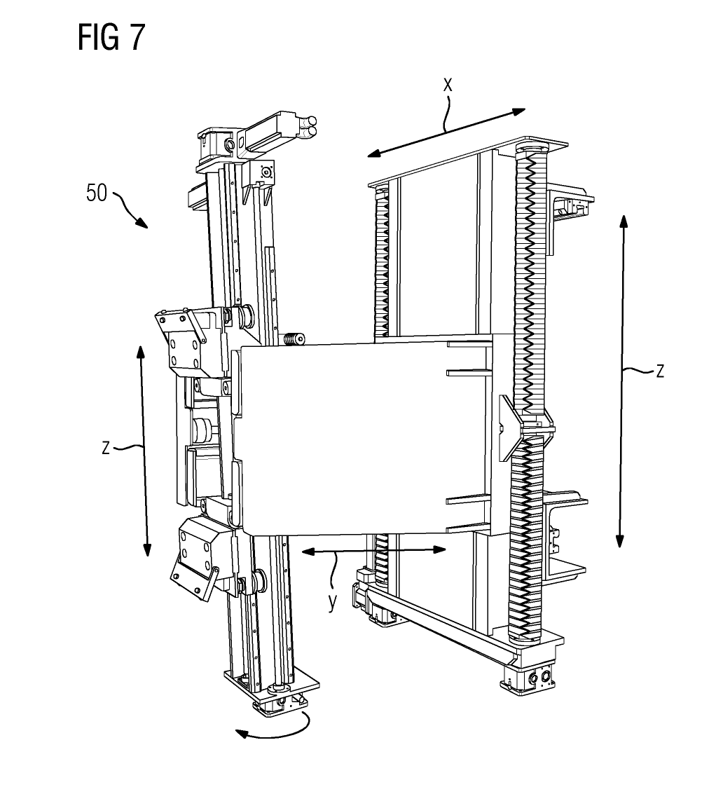

FIG. 7 an embodiment for a side wall alignment device for the assembly stand according to FIG. 1;

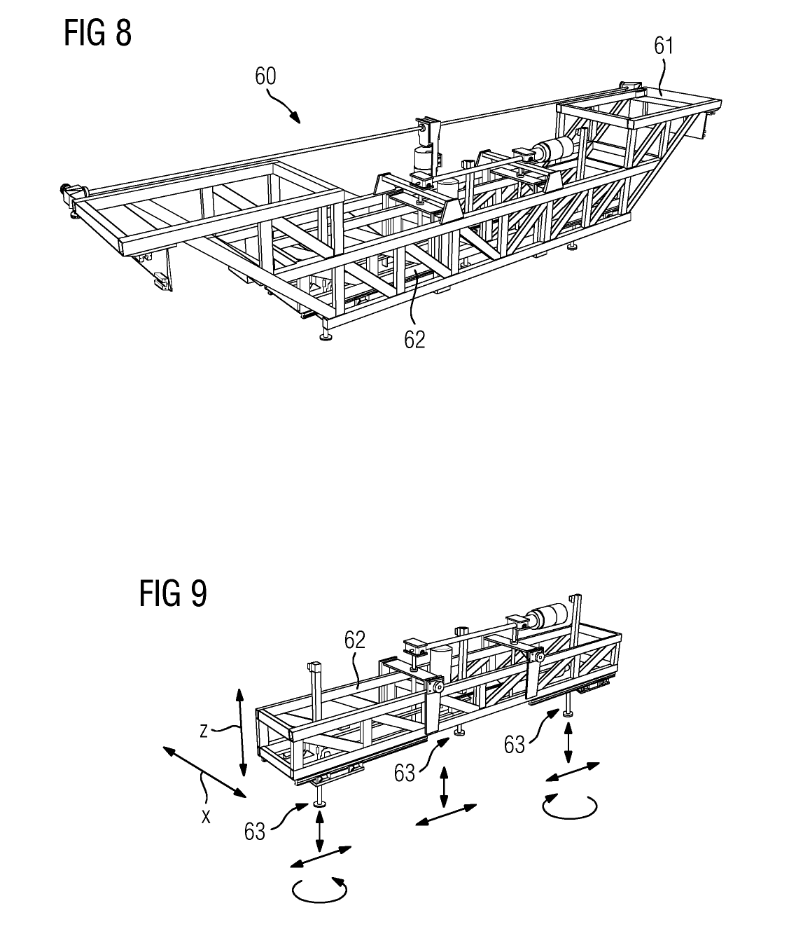

FIG. 8 an embodiment for a roof portal for the assembly stand according to FIG. 1;

FIG. 9 the roof portal according to FIG. 8 in a different view;

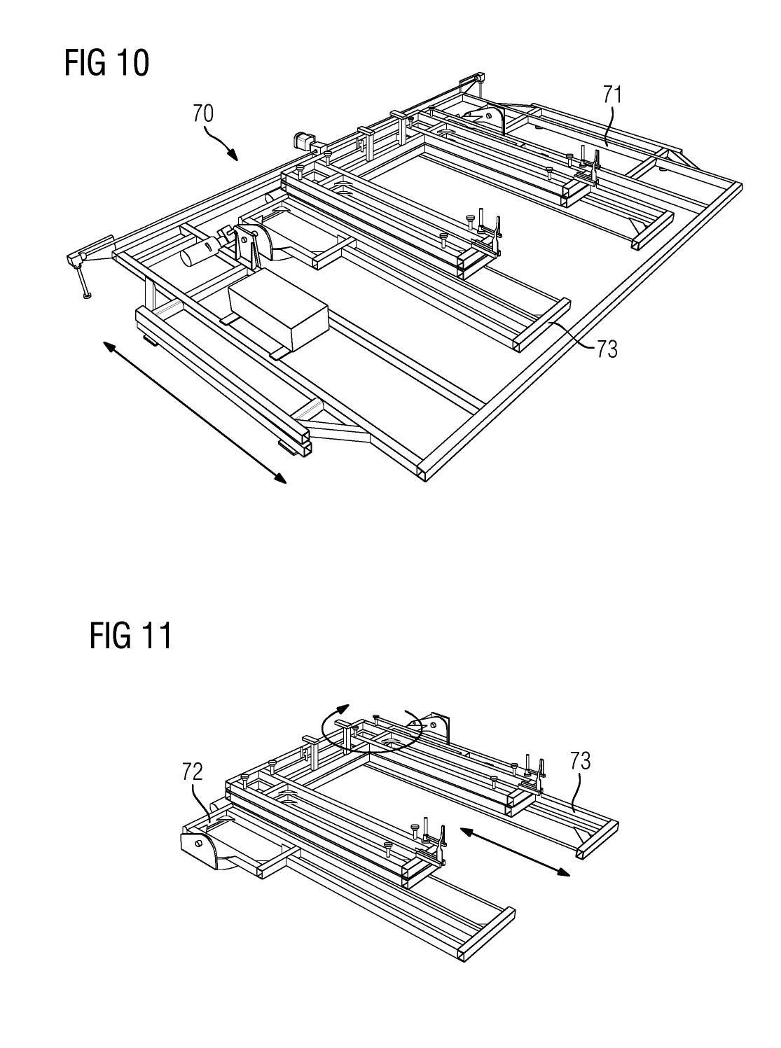

FIG. 10 an embodiment for an end wall holding device for the assembly stand according to FIG. 1;

FIG. 11 an interior frame of the end wall holding device in further detail;

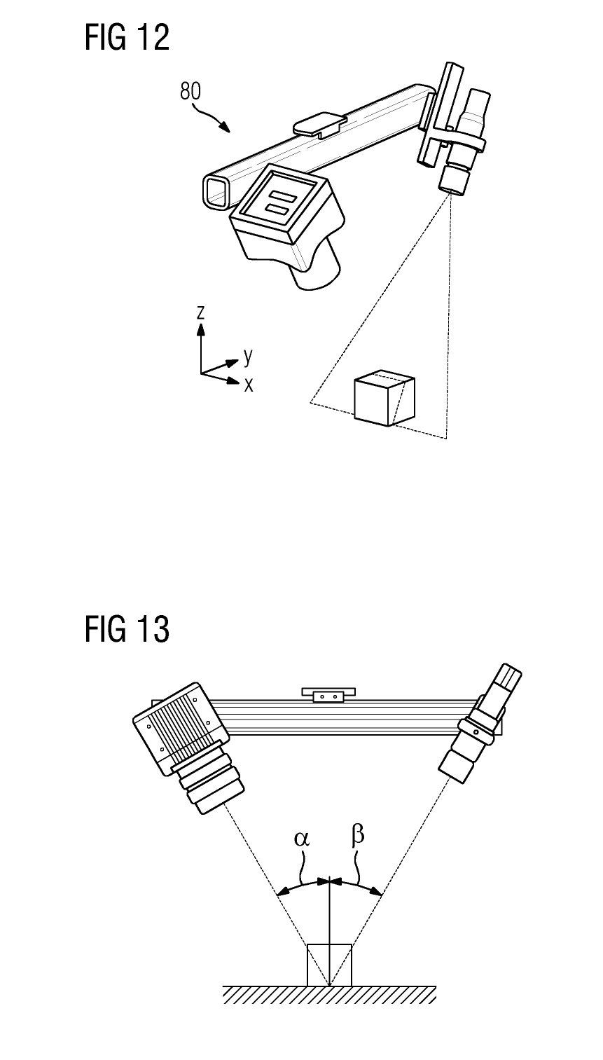

FIG. 12 an embodiment for a measuring device for the assembly stand according to FIG. 1; and

FIG. 13 the method of operating the measuring device according to FIG. 12, in a view from the side.

For clarity, the same reference numerals are always used in the drawings for identical or comparable components.

FIG. 1 shows an embodiment for an assembly stand 10 which is suitable for putting together railcar body units to form a railcar body of a railway vehicle. The assembly stand 10 has inter alia an inner unit 20 of which in FIG. 1 a longitudinal beam 21 is seen which rests horizontally movable on a support bearing 22.

FIG. 2 shows the inner unit 20 of the assembly stand in further detail. The longitudinal beam 21 is seen which rests on the support bearing 22 so as to be displaceable along the y-direction. The support bearing 22 is held by two supports 23 which are displaceable along the vertically aligned z-direction.

As a result of the horizontal displacement of the longitudinal beam 21 on the support bearing 22 as well as through the adjustment of the supports 23 it is possible during assembly of a railcar body to position the longitudinal beam 21 quasi anywhere in the interior of the railcar body.

The longitudinal beam 21 preferably has a number of individually adjustable support devices 24 which can serve for supporting the railcar roof during assembly. For this, the longitudinal beam 21 need only be positioned accordingly by means of the support bearing 22 and the supports 23 so that the individually adjustable support devices 24 can bear the load of the railcar body roof. With a corresponding alignment of the longitudinal beam 21 this thus serves as a type of “counter bearing” for the railcar roof when the latter is pressed down onto the railcar body under-frame by means of pressure devices which are not shown in further detail in FIG. 2.

The longitudinal beam 21 furthermore preferably serves as a tool holder, by way of example for welding tractors, welding robots, riveting tools or other tools for hot- and/or cold-joining the railcar body units. If the longitudinal beam 21 is used as a support for welding appliances, then it is regarded advantageous if the longitudinal beam 21 undertakes the function of a mass introduction for the welding process. By way of example the individually adjustable support devices 24 can in addition to a support function also fulfill a mass introduction function, for example during the welding of the railcar body roof onto the side walls.

Since the longitudinal beam 21 is located in the interior of the railcar body during the assembly of the railcar body, assembly steps can be carried out automatically or automated from the interior, by way of example in the form of welding steps, support steps or the like.

FIG. 3 shows in further detail the longitudinal beam 21 as well as two individually displaceable support devices 24 located thereon. Both the support devices 24 and also other tools are preferably displaceable along the x-direction, thus along the longitudinal direction of the longitudinal beam 21 in order to enable an automated assembly of the railcar bodies.

FIG. 4 shows by way of example a scissor-lift table 30 which forms for the assembly stand 10 according to FIG. 1 the means for centering the under-frame of the railcar body. The scissor-lift table 30 can form, together with one or more further preferably structurally identical scissor-lift tables, one transport unit for the assembly stand 10 according to FIG. 1.

The function of the scissor-lift table 30 consists inter alia in carrying out a centering of the under-frame of the railcar body and in moving the under-frame into the assembly stand 10 according to FIG. 1 and positioning it there. It also makes it possible to move the finished assembled railcar body automatically out again from the working area. The crane occupation times can thus be markedly reduced by the scissor-lift tables 30 or by the transport unit formed by the scissor-lift tables. It is also possible to ensure with the scissor-lift tables 30 that transport damage to the under-frame, to the vehicle and to the assembly stand is prevented.

The lifting function of the scissor-lift tables 30 is preferably achieved with a lifting chain drive 31. The lifting capacity of the scissor-lift tables illustrated in FIG. 4 preferably amounts to between 5 and 10 tons or even more than 10 tons.

FIG. 5 shows an embodiment for a discharge device 40 which forms for the assembly stand 10 according to FIG. 1 means for discharging the under-frame of the railcar body. The discharge device 40 comprises a tension unit 41 which interacts with a lifting unit 42. The lifting unit 42 is driven by a drive 43 whose control is undertaken by a control device 44. FIG. 6 shows the discharge device 40 according to FIG. 5 once more but in a different view.

For receiving an under-frame of a railcar body several discharge devices 40 are preferably used, as shown in FIGS. 5 and 6. Thus as an under-frame is moved into the assembly stand the discharge devices 40 are first brought into a parking position in which they are located outside of the railcar contour. Only once the under-frame is positioned are the discharge devices 40 moved into their working position and for the purpose of discharge are brought into connection with the under-frame.

The discharge devices 40 enable the assembly stand to receive each under-frame individually and automated. The relevant under-frame parameters are for this purpose preferably memorized related to projects and railcar bodies.

FIG. 7 shows by way of example a side wall alignment unit 50 which forms for the assembly stand 10 according to FIG. 1 means for aligning the side walls of the railcar body. The side wall alignment unit 50 can be positioned in the vehicle longitudinal direction, thus in the x-direction. Furthermore it enables a width adjustment and alignment of the vertical position (y-direction). Height adjustment, inward movement and pressing down (z-direction) are also possible. Furthermore the side wall alignment unit 50 enables an incline adjustment of the side walls, a torsion compensation during inward movement as well as an adaption in any way to different types of side walls.

All movements of the side wall alignment unit 50 are advantageously executed in motorized manner. This makes it possible to carry out automatically all setting-up processes for receiving various different side walls. Also the work movements as a whole can be carried out automatically.

To assemble a side wall this is preferably taken up and held by the side wall alignment unit 50. The correct angular position of the side wall is created and maintained. The welding gap between the side wall and the under-frame is then maintained at “0” by the side wall alignment unit 50. This enables an automated welding without previously securing the side walls. The side wall alignment unit 50 advantageously holds the side wall in the railcar body contour predetermined in the railcar body blueprint. This makes it possible to dispense with struts and supports located on the inside. Dispensing with inner struts or supports enables an automated welding of the interior seams, by way of example using welding appliances which are mounted on the longitudinal beam of the inner unit according to FIGS. 2 and 3.

The position of a side wall held by the side wall alignment unit 50 is advantageously controlled by a section laser process and subsequently corrected when necessary.

FIGS. 8 and 9 show an embodiment for a roof portal 60 for the assembly stand 10 according to FIG. 1. The function of the roof portal 60 consists in pressing down the railcar body roof towards the railcar body under-frame in order to close the upper welding gap. It is thus no longer necessary for the railcar body roof to be pressed down by means of a crane and a constant weight. A crane is however still required to transport the roof into the assembly stand.

The roof portal 60 consists of an outer frame 61 as well as an inner frame 62 which is guided movable therein and on which pressure units 63 are mounted which after an adjustment of the roof portal 60 above the railcar body roof press down onto the railcar body roof. The pressure units 63 are advantageously adjustable both vertically and widthwise. The inner frame 62 is advantageously vertically adjustable relative to the outer frame in order to carry out a precision correction. The outer frame 61 is advantageously movable along the longitudinal axis of the railcar body, thus along the x-axis.

The assembly stand 10 according to FIG. 1 advantageously has a number of roof portals 60 which can be positioned individually. The roof portals 60 enable a force introduction which is reproducible and can be re-adjusted where necessary manually or through computer assistance.

FIGS. 10 and 11 show an embodiment for an end wall receiving device 70 for the assembly stand 10 according to FIG. 1. The end wall receiving device 70 forms for the assembly stand 10 according to FIG. 1 means for receiving an end wall unit of a railcar body, for transporting the end wall into each relevant assembly position, for positioning the end wall on a railcar body and for holding the end wall during fitting works on the railcar body.

The end wall receiving device 70 comprises inter alia an outer frame 71 which serves to position the receiver in the longitudinal direction. The end wall receiving device 70 comprises furthermore a swivel frame 72 which can be moved into a vertical assembly position for positioning the end wall.

An inner frame 73 of the end wall receiving device 70 serves to lower the end wall into each relevant assembly position and to adjust the height. It can be seen in FIGS. 10 and 11 that the inner frame 73 is displaceable relative to the outer frame 71. This makes it possible to move the end wall into the relevant required or desired assembly position each time.

The end wall receiving device 70 makes it possible to receive the end walls in automated manner and to position them on the railcar body in automated manner. The use of a crane is not required. Furthermore the end wall receiving device 70 allows the end walls to be adapted to the railcar body and facilitates the joining of the end walls as a whole.

FIG. 12 shows an embodiment for a measuring unit 80 for the assembly stand 10 according to FIG. 1. The measuring unit 80 comprises a laser and CCD sensor evaluating system which advantageously operates according to a light-section method.

Furthermore, digital signal processors are advantageously provided which for clarity are not shown in FIG. 12 and which serve for pre-processing the incoming measured data. The reduced or relevant data formed with the aid of digital signal processors are advantageously transmitted in digital form by the measuring unit 80 to a super-ordinate automation system, by way of example by the Ethernet. This enables the automation system to calculate a spot deviation of the position of a just mounted side or end wall in relation to a predetermined reference position and to send suitable correction signals to the gripper and assembly units of the relevant side wall alignment unit 50 (see FIG. 7) or the relevant end wall receiving device 70 (see FIGS. 10 and 11) in order to reach a corrected assembly.

The measuring device 80 can also be used to measure the width of the under-frame of the railcar body in order to ensure a correct positioning of the side walls on the longitudinal beams of the under-frame by means of the side wall alignment device 50 (see FIG. 7).

The measuring unit 80 can also be used to measure the position of the fitted side walls for the purpose of adjusting the required incline angle of the side walls for optimum fitting of the roof. With the measuring unit 80 it can thus be guaranteed that the mounted railcar bodies always each have the desired contour which is filed by way of example in the form of CAD data (“CAD-contour”), obviously whilst taking into account the permissible assembly tolerances each time.

The assembly stand 10 according to FIG. 1 enables inter alia the following work steps:
automated supplying, positioning and alignment of the under-frame in the assembly stand,
automated fixing and adjustment of the required discharge of the under-frame,
reproducible project- and railcar-specific adjustment of e.g. tensile force, pressure, route etc.,
automated positioning and alignment of the side walls relative to the under-frame,
automated and close-fitting lowering of the side walls onto the longitudinal beams,
automated adjustment of the “CAD-contour” of the resulting railcar body inside the permissible tolerance field through targeted adjustment of the angular position of the side walls,
automated pressing of the side walls and closing of the welding gaps by means of the side wall alignment unit 50 and compensation of distortions in the z-direction,
automatic and parallel joining, such as e.g. welding of inner and outer welding seams, without previous fixing (other joining methods, such as e.g. cold-joining technology, are also possible here),
automated support of the roof by means of the inner unit 20,
automatic measuring of the railcar body contour in the area of the side wall/roof join by means of the measuring device 80,
automated pressing of the roof and closing of the welding gaps by means of the roof portals 60,
automatic and parallel joining of the roof, such as e.g. welding of the inner and outer welding seams for the roof, without previous fixing (other joining methods, such as for example cold-joining technologies, are also possible here),
automated positioning and alignment of the end walls for adapting and welding the “vertical seams” by means of the end wall receiving unit 70 and automated removal of the railcar body out from the assembly stand by means of the scissor-lift tables 30, which form one transport unit for the assembly stand.

Overall the assembly stand 10 according to FIG. 1 has the following advantages:
The assembly stand can be used for all present-day and future types of railcar bodies independently of the structural design systems.
The assembly stand is independent of the materials used for the railcar bodies; thus railcar bodies of aluminum and/or steel can be put together.
Using the assembly stand, railcar bodies can be manufactured using the conventional joining and welding technology and also cold-joining technology.
The assembly stand enables a technically and economically expedient degree of automation and reduces the working expense and the run-through times compared with conventional assembly stands.
Project-specific contour pieces for adaption are no longer required.
Project-specific setting-up work is no longer required.

1-10. (canceled)

11. An assembly stand for putting together railcar body units to form a railcar of a railway vehicle, the assembly stand comprising:
an inner unit having a longitudinal beam configured to be present in an interior of the railcar body while putting the railcar body together, configured to extend along a longitudinal axis of the railcar body and configured to be positioned in the interior of the railcar body.

12. The assembly stand according to claim 11, wherein said longitudinal beam has a guide unit configured to move tools along a longitudinal axis of said longitudinal beam.

13. The assembly stand according to claim 11, wherein said longitudinal beam is dimensioned to support a roof of the railcar body from inside the railcar, while putting the railcar together.

14. The assembly stand according to claim 13, which further comprises at least one support device attached on an upper side of said longitudinal beam, said at least one support device configured to have the railcar body roof rest thereon when the railcar body roof is supported by the longitudinal beam.

15. The assembly stand according to claim 11, which further comprises:
at least one welding appliance movably attached on said longitudinal beam;
said longitudinal beam configured to provide for a mass introduction for a welding process through said at least one support device.

16. The assembly stand according to claim 11, which further comprises a centering device for centering an under-frame of the railcar body.

17. The assembly stand according to claim 11, which further comprises a discharge device for discharging an under-frame of the railcar body.

18. The assembly stand according to claim 11, which further comprises an aligning device for aligning at least one side wall of the railcar body.

19. The assembly stand according to claim 11, which further comprises a pressing device for pressing down a roof of the railcar.

20. The assembly stand according to claim 11, which further comprises a receiving device for at least one of receiving, transporting or positioning at least one end wall of the railcar body.
